(19) United States
(12) Patent Application Publication
(10) Pub. No.: US 2012/0075218 A1
(43) Pub. Date: Mar. 29, 2012

(54) TOUCH PANEL AND TOUCH DISPLAY DEVICE USING THE SAME

(75) Inventors: MING-CHUAN LIN, Taichung City (TW); Tien-Nan Wang, Taichung County (TW); Ying-Chi Wang, Knohsiung County (TW); Yung-Chang Lin, Taichung City (TW); Lin Lin, Taichung City (TW); Wen-Hung Wang, Taichung City (TW); Pei-Fang Tsai, Taichung County (TW); Shyh-Jeng Chen, Taichung County (TW)

(73) Assignees: WINTEK CORPORATION, Taichung City (TW); Wintek Technology Dongguan Ltd., Dongguan City (CN)

(21) Appl. No.: 13/238,255

(22) Filed: Sep. 21, 2011

(30) Foreign Application Priority Data
Sep. 24, 2010 (TW) 099132296

(51) Int. Cl. G06F 3/041

(52) U.S. Cl. 345/173

(57) ABSTRACT

A touch panel comprising a substrate, a touch element, a first grounding electrode, an insulation layer and a second grounding electrode is disclosed. The touch element is disposed on a first surface of the substrate. The first grounding electrode is disposed on the first surface to surround the touch element. The insulation layer is disposed on the first surface to cover the touch element and the first grounding electrode. The second grounding electrode is disposed on the first insulation layer or on a second surface of the substrate opposite to the first surface. Therefore, the ESD can be conducted to the grounding end G of the circuit component through the enclosed first grounding electrode, and the signal interference between the touch panel and display can be shielded by the second grounding electrode to enhance anti-ESD and anti-noise abilities of the touch panel.

### FIELD OF THE INVENTION

The present invention relates to a touch panel and the touch display device using the same, and more particularly, to a touch panel with grounding structure for diverting the electrostatic discharge (ESD) to the ground of the circuit component so as to protect the touch panel from ESD damage.

### BACKGROUND OF THE INVENTION

With rapid advance in user-friendly concept for promoting simplification in operation procedure, there are more and more touch display device used in various applications in our daily life. By the application of touch panel, the operation of many common electronic devices essential to our daily life for work or other uses can be greatly simplified and facilitated since it enables any user to input signals for controlling such electronic devices simply by touching the screens of those devices without operating other input devices, such as keyboard, mouse and joystick.

Technically speaking, there are four major types of touch panel in the market, which are resistive type, capacitive type, supersonic type, and optical (Infrared) type that are all being vastly applied in many consumer electronics, such as cellular phone, person digital assistant (PDA), etc. Since the touch panel is designed to be controlled by the touch of foreign objects, such as fingers or stylus, the ESD can be easily induced to damage the metal trace and electrodes of the touch panel such that the erroneous operation and unrecoverable breakdown are occural. Moreover, the control IC of the touch panel may be damaged when the ESD is conducted to the system.

Therefore, it is in need of a touch panel capable of achieving a complete ESD protection by guiding the ESD out of the touch panel.

### SUMMARY OF THE INVENTION

In view of the disadvantages of prior art, the primary object of the present invention is to provide a touch panel capable of utilizing a grounding structure for conducting the electrostatic discharge (ESD) to the ground of the circuit component so as to prevent from the ESD damage.

To achieve the above object, the present invention provides a touch panel comprising a substrate, a touch element, a first grounding electrode, an insulation layer and a second grounding electrode. The touch element is disposed on a first surface of the substrate. The first grounding electrode is disposed on the first surface to surround the touch element. The insulation layer is disposed on the first surface to cover the touch element and the first grounding electrode. The second grounding electrode is disposed on the first insulation layer or on a second surface of the substrate opposite to the first surface.

Moreover, the present invention provides a touch display device comprising a substrate, a touch element, a first grounding electrode, an insulation layer, a second grounding electrode and a display. The touch element is disposed on a first surface of the substrate. The first grounding electrode is disposed on the first surface to surround the touch element. The insulation layer is disposed on the first surface to cover the touch element and the first grounding electrode. The second grounding electrode is disposed on the first insulation layer or on a second surface of the substrate opposite to the first surface. The display is disposed on the second grounding electrode. Therefore, the ESD can be conducted to the ground G of the circuit component through the enclosed first grounding electrode, and the signal interference between the touch panel 50 and display can be shielded by the second grounding electrode to enhance anti-ESD and anti-noise abilities of the touch panel.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a front view of a touch panel according to an embodiment of the invention.

FIG. 2 is a cross section view of a touch panel according to an embodiment of the invention.

FIG. 3 is a cross section view of a touch panel according to another embodiment of the invention.

FIG. 4 is a cross section view of a touch display device according to an embodiment of the invention.

FIG. 5 is a cross section view of a touch display device using a touch panel with double-layered substrate according to another embodiment of the invention.

FIG. 6 is a cross section view of another embodiment of the touch panel including the sensing electrode disposed on the substrate above the color filter substrate.

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

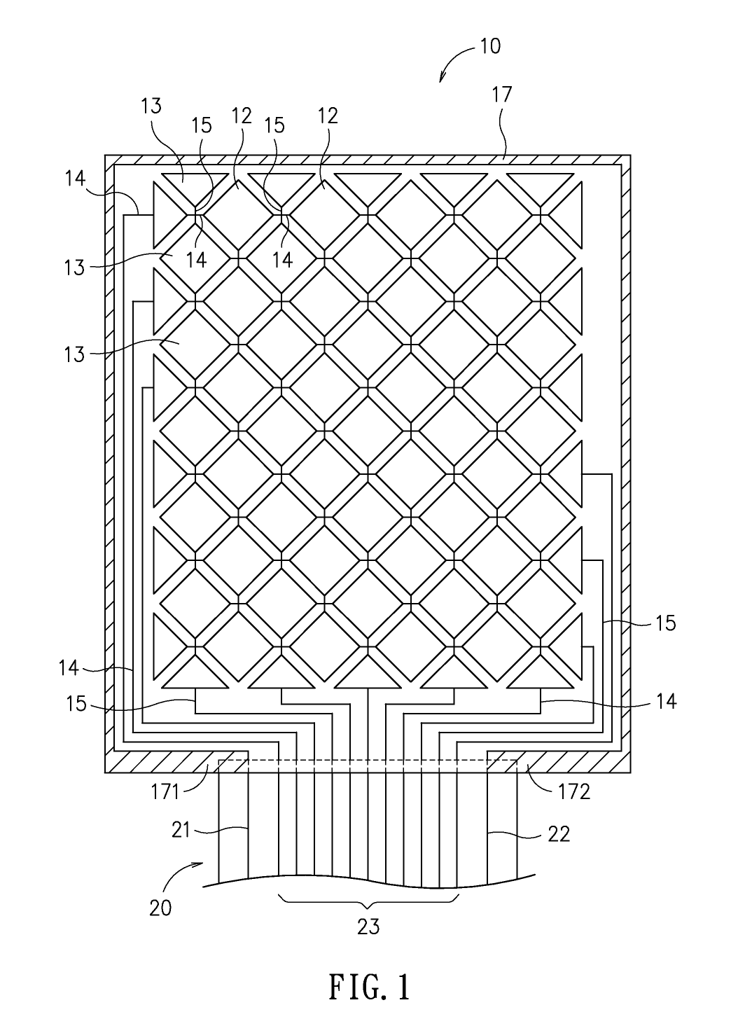

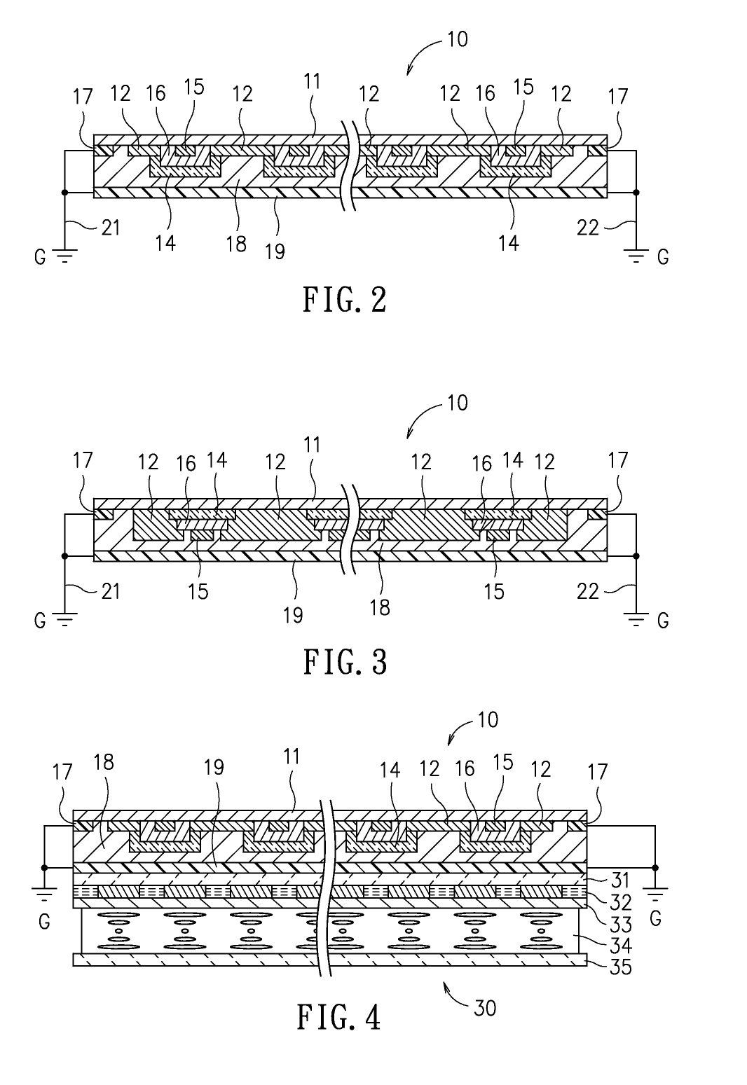

Please refer to FIG. 1, which is a front view of a touch panel according to an embodiment of the invention. The touch panel 10 is connected with a circuit component 20 that can be a flexible printed circuit(FPC) in this embodiment. In other embodiments, the circuit component 20 can be a control IC or a system device. In FIG. 1, the circuit component 20 is configured with a first grounding line 21, a second grounding line 22, and a plurality of connecting lines 23 disposed between the first grounding line 21 and the second grounding line 22. As shown in FIG. 2, the first grounding line 21 and the second grounding line 22 are connected to the ground G of the circuit component 20. Moreover, generally those grounding lines and connecting lines are covered and concealed by a decorative layer made of resins, inks, or diamond-like materials.

As shown in FIG. 1 and FIG. 2, the touch panel 10 has a transparent substrate 11, which can be a color filter, a cover lens, or a polarizer wherein the cover lens can be made of plastic or glass. In FIG. 2, a touch element is mounted on a surface of the substrate 11, and comprises a plurality of first sensing electrodes 12, a plurality of second sensing electrodes 13, a plurality of first wires 14 and a plurality of second wires 15. In addition, the first sensing electrodes 12 and the second sensing electrodes 13 are disposed intersectingly on the substrate 11, the first sensing electrodes 12 are connected with each other by the first wires 14, and the second sensing electrodes 13 are connected with each other by the second wires 15 wherein an insulation layer 16 is disposed on the second wires 15 to prevent form short circuit between the first wires 14 and the second wires 15. In FIG. 1, the first wires 14 and the second wires are extending to an edge of the substrate 11(the bottom edge of the substrate 11 in this embodiment) to connect with the corresponding connecting lines 23 of the circuit component 20.

Moreover, there is a first grounding electrode 17 mounted on the surface of the substrate 11 where the touch element is disposed, and disposed at the peripheral of the substrate 11 to expose the outer edge of the first grounding electrode 17. As shown in FIG. 1, the first grounding electrode 17 comprises a first end 171 and a second end 172 extending to an edge of the substrate 11(the bottom edge of the substrate 11 in this embodiment) for respectively connecting to the first grounding line 21 and the second grounding line 22 of the circuit component 20. Accordingly, the first sensing electrodes 12, the second sensing electrodes 13, the first wires 14, and the second wires 15 are surrounded by the first grounding electrode 17 between the first end 171 and the second end 172. Moreover, the first sensing electrodes 12, the second sensing electrodes 13, the first wires 14, the second wires 15 and the first grounding electrode 17 are covered by an insulation layer 18, as shown in FIG. 2, and there is a second grounding electrode 19 disposed on the surface of the insulation layer 18 opposite to the surface where the first grounding electrode 17 and the touch element is disposed. The second grounding electrode 19 is arranged to cover the insulation layer 18, and electrically connected to the first grounding line 21 and the second grounding line 22 of the circuit component 20.

Please refer to FIG. 3, which is a cross section view of a touch panel according to another embodiment of the invention. The embodiment of FIG. 3 is different from that shown in FIG. 2 in the configuration of the first wires 14. In this embodiment, the first wires 14 connected between the first sensing electrodes 12 are formed prior to the processes for sequentially forming the insulation layer 16, the first sensing electrodes 12 and the second sensing electrodes 13. The first grounding electrode 17 is manufactured in the process of patterning the first wires 14 by modifying the pattern of the mask to prevent from increasing the manufacturing step and cost. In addition, the first grounding electrode 17 and the second grounding electrode 19 can be connected to the first grounding line 21 or the second grounding line 22, but the connection should not be limited thereof. Similarly, if there is only one grounding end in the circuit component, the first grounding line 21 and the second grounding line 22 can both being connected to the single grounding end. However, if there are three or more than three grounding ends, the first grounding line 21 and the second grounding line 22 can be connected to any one, two or more, or even all of the grounding ends as required.

Please refer to FIG. 4, which is a cross section view of a touch display device according to an embodiment of the invention. In FIG. 4, the touch display device 30 includes a color filter substrate 31, a color filter 32, a common electrode 33, a liquid crystal layer 34, a TFT-array substrate 35 and a touch panel 10 wherein the touch panel 10 is disposed on the color filter substrate 31. Accordingly, the ESD can be conducted to the ground G of the circuit component 20 shown in FIG. 1 through the enclosed first grounding electrode 17. Moreover, the second grounding electrode 19 mounted at the bottom of the touch panel 10 is provided as a shielding layer for suppressing signal interference between the touch panel 10 and the common electrode 33. Thus, the anti-ESD and anti-noise abilities of the touch panel 10 are enhanced.

It is apparent that the touch panel disclosed in the present invention is not limited to be any specific type of touch panel. Thus, in addition to the sensor-on-cover-glass type structure, the touch panel of the invention can also adopt the conventional structure of double-layered substrate, or the structure having the sensing electrodes to be disposed on top or bottom of a glass substrate proximate to the color filter of the liquid crystal display. It is noted that the display used in the touch display device in the above embodiment are only for illustration and thus are not limited thereby. Thus, the display can be a liquid crystal display (LCD), a bistable display, an organic light-emitting display (OLED) or an electro-wetting display (EWD).

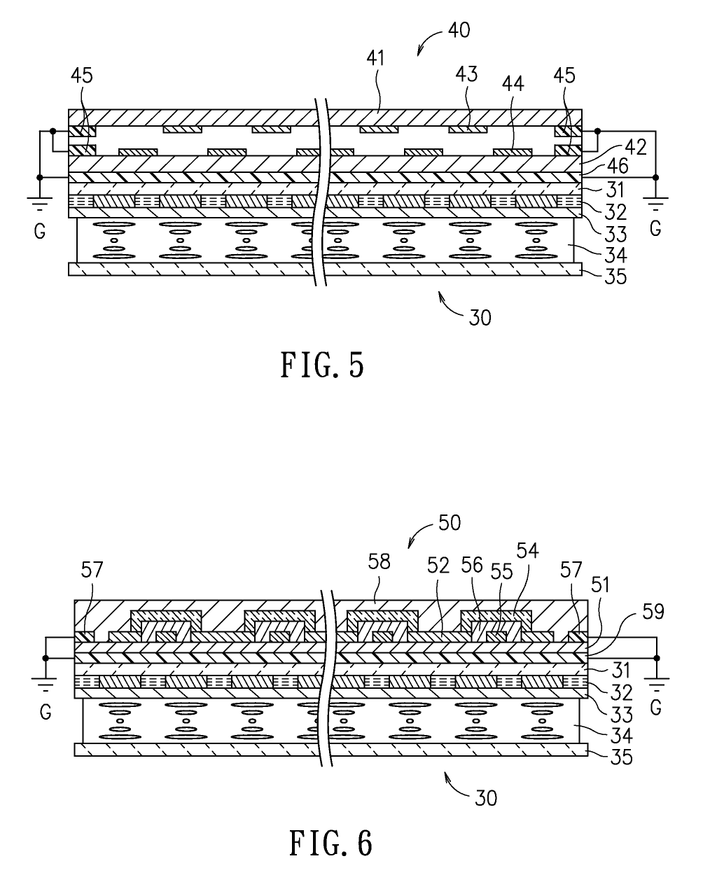

Please refer to FIG. 5, which is a cross section view of a touch display device using a touch panel with double-layered substrate according to another embodiment of the invention. The touch panel 40 includes a top substrate 41 with top sensing electrodes 43 and a bottom substrate 42 with bottom sensing electrodes 44 wherein the first grounding electrodes 45 are respectively disposed on the top substrate 41 and the bottom substrate 42 to surround the top sensing electrodes 43 and the bottom sensing electrodes 44. In addition, the second grounding electrode 46 is disposed on the surface opposite to the surface where the bottom sensing electrodes 44 is disposed. Therefore, the ESD can be conducted to the ground G of the circuit component 20 through the enclosed first grounding electrodes 45, and the signal interference between the touch panel 40 and the common electrode 33 of the liquid crystal display 30 can be shielded by the second grounding electrode 46 to enhance anti-ESD and anti-noise abilities of the touch panel 40.

Please refer to FIG. 6, which is another embodiment of the touch panel including the sensing electrode disposed on the substrate above the color filter substrate. The touch element of the touch panel 50 includes a substrate 51, a plurality of first sensing electrodes 52, a plurality of second sensing electrodes (not shown), a plurality of first wires 54, a plurality of second wires 55 and an insulation layer 56 wherein the first sensing electrodes 52 connected with the first wires 54 and the second sensing electrodes connected with the second wires 55 are disposed on the substrate 51, and the insulation layer 56 is disposed between the first wires 54 and the second wires 55. Moreover, the touch panel 50 further includes a first grounding electrode 57 surrounding the touch element and an insulation layer 58 covering the first sensing electrodes 52, the first wires 54, the second sensing electrodes, the second wires 55 and the first grounding electrode 57. In addition, the second grounding electrode 59 is disposed on the surface opposite to the surface where the touch element is disposed. Therefore, the ESD can be conducted to the ground G of the circuit component through the enclosed first grounding electrode 57, and the signal interference between the touch panel 50 and the common electrode 33 of the liquid crystal display 30 can be shielded by the second grounding electrode 59 to enhance anti-ESD and anti-noise abilities of the touch panel 40.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

What is claimed is:

1. A touch panel, comprising:
at least one first substrate;
at least one touch element, disposed on a first surface of the first substrate;
at least one first grounding electrode, disposed on the first surface to surround the touch element;
a first insulation layer, disposed on the first surface to cover the touch element and the first grounding electrode; and
a second grounding electrode, disposed on the first insulation layer or on a second surface of the first substrate opposite to the first surface.

2. The touch panel of claim 1, wherein the first grounding electrode is disposed at the peripheral of the first substrate to expose the outer edge of the first grounding electrode.

3. The touch panel of claim 1, wherein the touch element comprises a plurality of first sensing electrodes, a plurality of second sensing electrodes, a plurality of first wires, a plurality of second wires and a second insulation layer wherein the first sensing electrodes connected with the first wires and the second sensing electrodes connected with the second wires are disposed intersectingly, and the second insulation layer is disposed between the first wires and the second wires.

4. The touch panel of claim 3, wherein the first wires are formed simultaneously with the first grounding electrode at the same manufacturing process.

5. The touch panel of claim 3, wherein the first substrate is a color filter substrate, a cover lens or a polarizer.

6. The touch panel of claim 5, wherein the cover lens is made of glass or plastic.

7. The touch panel of claim 1, further comprising a second substrate wherein the touch element comprises multiple top sensing electrodes disposed on the second substrate and multiple bottom sensing electrodes disposed on the first substrate, the first grounding electrodes are respectively disposed on the first substrate and the second substrate to surround the top sensing electrodes and the bottom sensing electrodes, and the second grounding electrode is disposed on the second surface of the first substrate.

8. A touch display device, comprising:
at least one substrate;
at least one touch element, disposed on a first surface of the substrate;
at least one first grounding electrode, disposed on the first surface to surround the touch element;
an insulation layer, disposed on the first surface to cover the touch element and the first grounding electrode;
a second grounding electrode, disposed on the insulation layer or on a second surface of the substrate opposite to the first surface; and
a display, disposed on the second grounding electrode.

9. The touch display device of claim 8, wherein the display is a liquid crystal display (LCD), a bistable display, an organic light-emitting display (OLED) or an electro-wetting display (EWD).
